(19) United States
(12) Patent Application Publication
(10) Pub. No.: US 2012/0044855 A1
(43) Pub. Date: Feb. 23, 2012

(54) Communication Method In An Automatic System

(76) Inventors: Mattias Lampe, Wolfenbuettel (DE); Hui Li, Beijing (CN); Jörg Müller, Linkenheim (DE); Ji Feng Tian, Beijing (CN)

(21) Appl. No.: 13/318,258

(22) PCT Filed: Apr. 30, 2009
(86) PCT No.: PCT/CN09/71582

§ 371 Date: Oct. 31, 2011

(51) Int. Cl. H04W 4/06

(52) U.S. Cl. 370/312

(57) ABSTRACT

A communication method in an automation system, wherein the system comprises an access point and client terminals that receive downlink data sent from the access point and send uplink data to the access point, and the data transmission is divided into a master multiple receiver aggregation phase and more than one slave multiple receiver aggregation phases. During the master multiple receiver aggregation phase, the access point aggregates the data to be sent to the plurality of client terminals into one packet for transmitting in the downlink, and during the slave multiple receiver aggregation phases, the access point aggregates data in which errors have occurred when being transmitted during the master multiple receiver aggregation phase into one packet for transmitting in the downlink. The method can have strict control, through the access point and over the uplink and downlink data transmission, thus enhancing the certainty during automation communication and further reducing the cycle time.

### CROSS-REFERENCE TO RELATED APPLICATIONS

This is a U.S. national stage of application No. PCT/CN2009/071582 filed 30 Apr. 2009, the content of which is incorporated herein by reference in its entirety.

### BACKGROUND OF THE INVENTION

1. Field of the Invention

The present invention relates to a communication method in an automation system and, more particularly, to a communication method which is used to perform real-time deterministic communication in an automation system.

2. Description of the Related Art

In the series of automation products SIMATIC, the PROFINET IO protocol (PNIO protocol) is used between distributed I/O devices and an I/O controller to perform fast and effective data exchange. The PROFINET IO protocol introduces the industrial Ethernet technology into the field at first level. The PNIO communication is acyclic communication, and in this communication mechanism, the I/O controller communicates with each of the I/O devices one by one within a time interval that is determined in advance. The time interval is referred to as the cycle time or PNIO updating time, and this time interval must be less than the time cycle of each I/O device that is accessed. In order to ensure that the I/O devices can be controlled accurately, the above cycle time must be as short as possible. Therefore, the difficulties faced by such cyclic communication systems, with the PNIO communication as an example, are: first of all, the initial communication certainty between the I/O controller and the I/O devices needs to be ensured, i.e., the I/O controller is made to communicate with a designated I/O device within a determined time period. Secondly, the cycle time should number of the I/O devices is increased. In industrial fields, both of the above two points are achieved by the PROFINET standards. When the real-time communication is performed by using the PROFINET IO, a rather typical example is that the cycle time can reach 8 ms in cases where there are 60 I/O devices.

Currently, as wireless networks are becoming increasingly popular, wireless LAN (WLAN) devices have also been introduced into the automation systems, so that another communication connection mode is provided when cable connections cannot be effectively used with mobile devices. FIG. 1 provides a schematic diagram of a WLAN communication using the PNIO protocol. In this case, an access point (AP) is located in the center and the four devices around it are client terminals (STA).

However, in WLAN communication based on the PNIO protocol, the difficulties faced by the cyclic communication are even more prominent. This is because a distributed coordination function (DCF) is initially used in the normal WLAN system to provide a channel access solution. That is, all the client terminals have identical priority to access the channel at any time. It is apparent that since the data volume to be transmitted by some client terminals may be very large, it is very difficult for this solution to ensure the certainty and instantaneity of the communication. Secondly, it is necessary to introduce a distributed inter frame space (DIFS) and an index backoff solution before transmitting the real data to avoid causing collisions in the channel access process. However, in these two solutions, in order to ensure that each device is able to transmit data, a large amount of additional overheads are required, and these overheads would then increase the cycle time.

In order to ensure that deterministic communication can be performed between the I/O devices and the I/O controller, some channel access solutions that are fully or partly controlled by the AP are proposed in the prior art. For example, a point coordination function (PCF) is also proposed together with the above DCF solution in the 802.11 standards. The PCF solution is based on a polling mechanism. That is, the access point (AP) inquires into each client terminal (STA) according to a polling list located thereon. The client terminal (STA) can access the channel only after having obtained an inquiry from the access point. For the data exchange in the PCF solution, reference can be made to FIG. 2. Here, D1 indicates the transfer of downlink data from the access point AP to a client terminal STA1, D2 indicates the transfer of downlink data from the access point AP to a client terminal STA2, and D3 indicates the transfer of downlink data from the access point AP to a client terminal STA3. When the access point AP transfers downlink data to the client terminal STA1, the AP first puts the data D1 to be sent to STA1 together with a poll packet Poll1 to send them to STA1. After having received the above packet, STA1 first decapsulates the data, which the access point AP requires to be sent by itself, from the Poll1 packet, then STA1 first sends an acknowledgement ACK for the downlink data sent by the access point AP, and then sends uplink data to the access point AP. For the received uplink data that is sent by STA1, the access point AP sends an acknowledgement ACK. When the downlink data is transferred from the access point AP to client terminals STA2 and STA3, this is also performed according to the above steps.

Although the PCF solution has a degree of certainty in communication, it does not have complete certainty. In other words, the PCF solution can achieve the control of each client terminal STA through the access point AP over the downlink, thus achieving real-time and determinate communication over the downlink. It is still not possible, however, to ensure communication certainty over the uplink. For example, the packet sent by STA1 to the access point AP may be very long, so that the access point AP cannot be certain about the specific time when the packet to STA2 is sent the next time. In addition, at the moment, the PCF solution still does not have effective hardware support. The above two aspects of defects are the reasons for the PCF not having widespread application.

Based on the above solutions, a novel multiple receiver aggregation (MRA) solution is proposed to solve the problem of cyclic communication. The MRA solution is achieved by the expansion of the single-receiver aggregation (SRA) solution in the current 802.11n standards. The basic idea of SRA is to have several packets to be sent to a client terminal STA by the access point AP aggregated together, so as to form a bigger packet for sending. Two aggregation methods in SRA are respectively the aggregate MAC protocol data unit (A-MPDU) method and the aggregate MAC service data unit (A-MSDU) method. The basic idea of MRA is to have the packets to be sent to a plurality of client terminals STA1, STA2, and STA3 by the access point AP aggregated together, so as to form a big physical layer convergence protocol (PLOP) service data unit (PSDU), which is referred to as an MRA frame. Before transmitting an MRA frame, it is necessary to initially send a management frame, which is referred to as a multiple receiver aggregation multi-poll frame (MMP). FIG. 3 shows the frame format of an MMP.

An MMP frame contains some information indicating how the client terminals which support MRA receive the packets sent by the access point AP and send the packets from each client terminal, and the indication information is centralized in a receiver info field in the MMP frame. Specifically, there is an Rx Offset for indicating when the client terminals which support MRA receive downlink data, a Tx Offset for indicating when the client terminals which support MRA send uplink data, an Rx Duration for indicating the length or the duration of the packets received by the client terminals which support MRA, and a Tx Duration for indicating the length or the duration of the packets sent by the client terminals which support MRA.

A typical sequence that uses the MRA solution to perform data exchange is shown in FIG. 4. In FIG. 4, there is one access point and five client terminals. The access point AP aggregates the downlink data D1, D2, D3, D4, and D5 to be sent to five (5) client terminals into an MRA frame for transmitting, and the MRA frame further includes an MMP frame that is located in the front of the data. In the MMP frame, there are five (5) receiver info fields for indicating respectively how 5 client terminals receive the packets sent by the access point AP and send the packets of each client terminal. Here, the client terminal STA1 sends an acknowledgement BA of the received data D1 to the access point AP after having received the data D1, the duration of which is Rx Duration, according to the time designated by Rx Offset in the receiver information field 1. In addition, the client terminal STA1 further sends the data U1, the duration of which is Tx Duration, according to the time designated by Tx Offset in the receiver information field 1. The client terminal STA1 can aggregate the uplink data U1 with its acknowledgement BA of the downlink data D1 together, so as to send them to the access point AP. The access point AP sends out its acknowledgement BA of the uplink data U1 after having received this uplink data U1, and this BA is the first BA located at the upper right in FIG. 4. It can be seen that, in the MRA solution, both the uplink and the downlink can be strictly controlled over the access point AP. In addition, the packets sent to all the client terminals are aggregated. As a result, the time expenditure in the downlink communication is reduced and the cycle time is shortened effectively.

However, there are still problems when the MRA solution is used in communication. Firstly, the acknowledgement BA for the uplink packet takes a relatively long time. This is because the acknowledgement for the downlink packet can be achieved by aggregating the acknowledgement into the uplink packet by way of aggregation or by changing one bit of the uplink packet. Accordingly, the acknowledgement for the downlink packet does not cost too much time. However, the acknowledgement for the uplink packet cannot be achieved in the way mentioned above. As a result, the acknowledgement for the uplink packet has to take a certain time by itself. In this way, in the case where there are quite a few client terminals, the access point will take a relatively long time to perform acknowledgement of the uplink data sent by each client terminal. For example, in the case where there are 60 client terminals, the PSDU length aggregated by all the acknowledgements for the uplink packet would be 1198 bytes, and assuming that the transmission rate is 6 Mbps, then it would cost a time of more than 1.6 ms to perform acknowledgement of the uplink packet. Secondly, the MRA solution only provides a basic data transmission sequence but does not give consideration to a retransmission mechanism when errors occur in the packets. Therefore, the application of the MRA solution is limited.

### SUMMARY OF THE INVENTION

It is an object of the present invention to provide a communication method in an automation system, in which determinate and real-time communication can be performed in a practical way in the automation system by using the method, so as to have the communication cycle time shortened as much as possible.

This and other objects and advantages are achieved in accordance with the present invention by a communication method in an automation system comprising an access point and more than one client terminal, in which client terminals receive downlink data sent from the access point and send uplink data to the access point, and the data transmission is divided into a master multiple receiver aggregation phase and more than one slave multiple receiver aggregation phases. During the master multiple receiver aggregation phase, the access point aggregates the data to be sent to the more than one client terminals into one packet for transmitting in the downlink, and during the slave multiple receiver aggregation phases, the access point aggregates the data that have errors which happened therein when being transmitted during the master multiple receiver aggregation phase into one packet for transmitting in the downlink.

Preferably, during the slave multiple receiver aggregation phases, the access point first aggregates the data that have errors that happened therein when being transmitted during a previous phase into one packet for transmitting in the downlink, and then the client terminals transmit to the access point the uplink data having errors that happened therein when being transmitted during the previous phase. Here, the previous phase is a master multiple receiver aggregation phase or a previous one of the slave multiple receiver aggregation phases.

In this case, each of the client terminals sends an acknowledgement of the received downlink data, together with the uplink data that is to be sent thereby, to the access point over the uplink.

In addition, the packet that is sent during the master multiple receiver aggregation phase comprises a master multiple receiver aggregation multi-poll frame for indicating that the data is transmitted from the access point to the more than one client terminals the downlink for the first time and indicating that the data is transmitted from the client terminals to the access point over the uplink for the first time. The packet that is sent during the slave multiple receiver aggregation phase comprises a slave multiple receiver aggregation multi-poll frame for indicating that the data is retransmitted from the access point to more than one client terminals over the downlink and indicating that the data is retransmitted from the client terminals to the access point over the uplink.

Preferably, the slave multiple receiver aggregation multi-poll frame comprises more than one receiver information fields, with each of the receiver information fields corresponding to one of the client terminals and each of the receiver information fields including four fields for respectively indicating the time when the client terminal receives the downlink data sent from the access point, the length of the received downlink data, the time when the client terminal sends the uplink data to said access point, and the length of the sent uplink data.

Preferably, the receiver information fields for indicating the time when the client terminal sends the uplink data to the access point and the length of the sent uplink data of the slave multiple receiver aggregation multi-poll frame are set to acknowledge the uplink data sent by the client terminals during the previous phase.

Here, the master multiple receiver aggregation multi-poll frame and the slave multiple receiver aggregation multi-poll frame are defined in a reserved domain in the multiple receiver aggregation multi-poll frame. Preferably, the master multiple receiver aggregation multi-poll frame and said slave multiple receiver aggregation multi-poll frame are defined by two bits in the reserved domain.

The present invention provides a method with stronger certainty for the communication between the access point and the client terminals. First of all, the present method can not only strictly control the downlink data transmission through the access point but also strictly control the uplink data transmission via the access point. Secondly, the method of the present invention expands the original MRA solution, dividing a master-MRA phase and a slave-MRA phase for data retransmission based on the MRA, which makes the present invention have more practical applicability. Furthermore, the present invention further divides the MMP frame into a master-MMP frame and a slave-MMP frame. As compared to the MMP, the slave-MMP frame replaces the function of performing acknowledgement of the uplink in the MMP, and as compared to the MRA solution, the cycle time is further shortened.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Hereinbelow, the particular embodiments of the present invention will be further described in detail in conjunction with the accompanying drawings, in which:

FIG. 1 is a schematic diagram of a WLAN communication using the PNIO protocol in accordance with the prior art;

FIG. 2 is a schematic diagram of data exchange in the PCF solution in accordance with the prior art;

FIG. 3 is an MMP frame format in accordance with the prior art;

FIG. 4 is a schematic diagram of a typical sequence which uses an MRA solution to perform data exchange in accordance with the prior art;

FIG. 5 is a schematic diagram of a sequence which uses the master-slave MRA solution for performing data exchange in according with the present invention;

FIG. 6 is a schematic block diagram illustrating modification of the format of an MMP frame when the master-slave MRA in accordance with the present invention;

FIG. 7 is a simulation result, in which the cycle time of the PCF, MRA and master-slave MRA solutions are compared in the case where the BER is 10⁻⁵ and the length of the packets is different; and

FIG. 8 is a flowchart of a method in accordance with an embodiment of the invention.

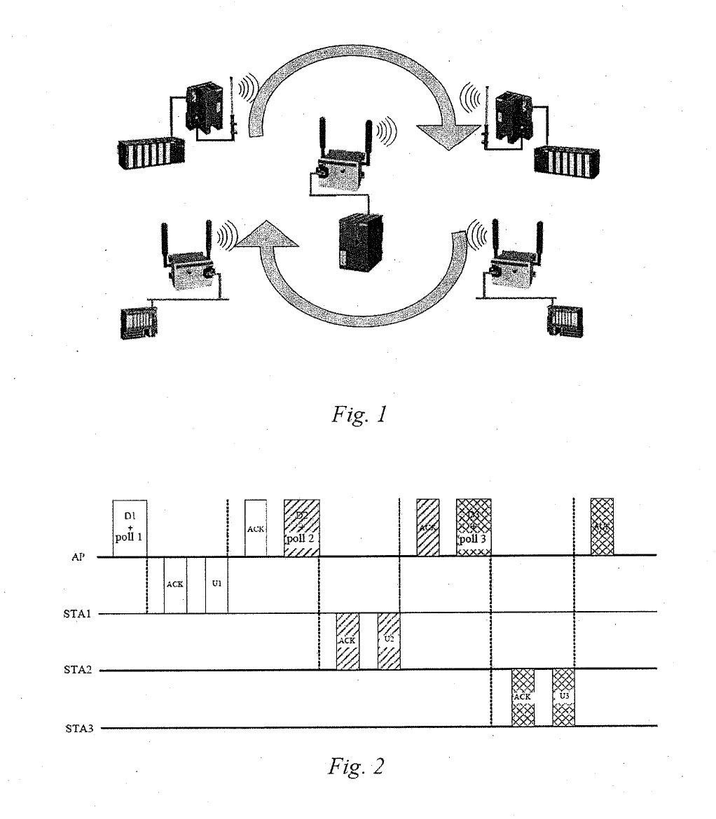

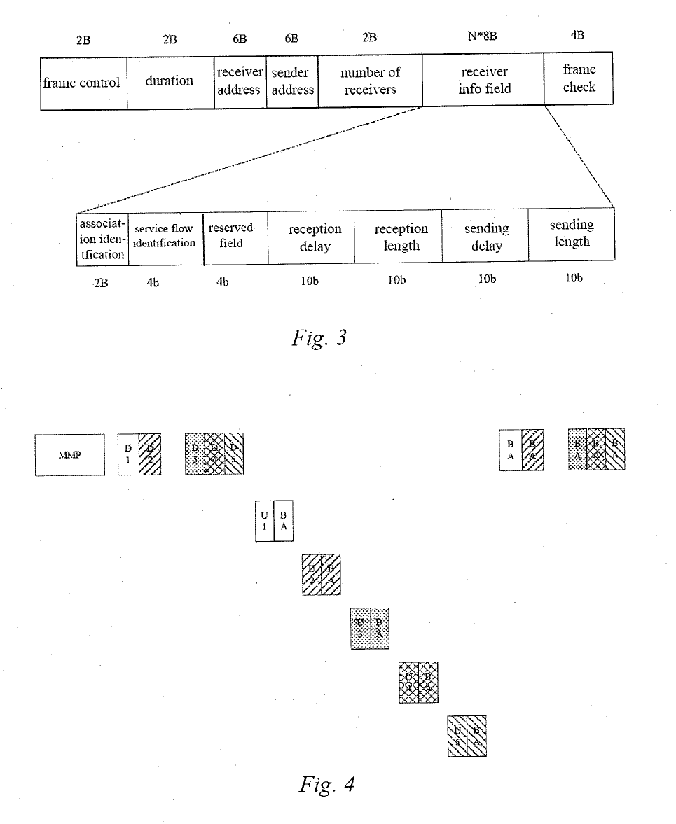

### DETAILED DESCRIPTION OF THE PREFERRED EMBODIMENTS

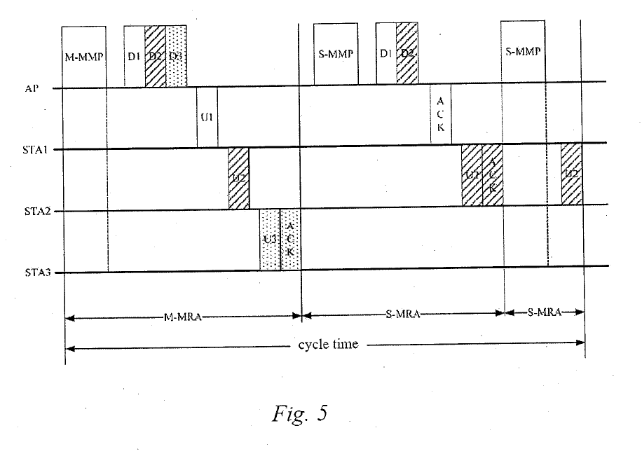

FIG. 5 is a schematic diagram of a sequence that uses the master-slave MRA method of the present invention to perform data exchange. The automation communication system in FIG. 5 comprises an access point AP and three client terminals STA1, STA2, and STA3. The access point AP sends downlink data to the client terminals STA1, STA2, and STA3, and the client terminals STA1, STA2, and STA3 respectively send uplink data to the access point AP.

In accordance with the method of the present invention, the data exchange process between the access point AP and three client terminals STA1, STA2, and STA3 is divided into two phases, which respectively are a master multiple receiver aggregation phase (Master-MRA) and two slave multiple receiver aggregation phases (Slave-MRAs).

During the master multiple receiver aggregation phase (Master-MRA), the access point AP aggregates the data to be sent to client terminals STA1, STA2, and STA3 into one packet, which packet includes a master multiple receiver aggregation multi-poll frame (Master-MMP). Since there are three client terminals in this embodiment, the master-MMP also has three receiver info fields, with each receiver info field defining a data receiving and sending situation for a client terminal.

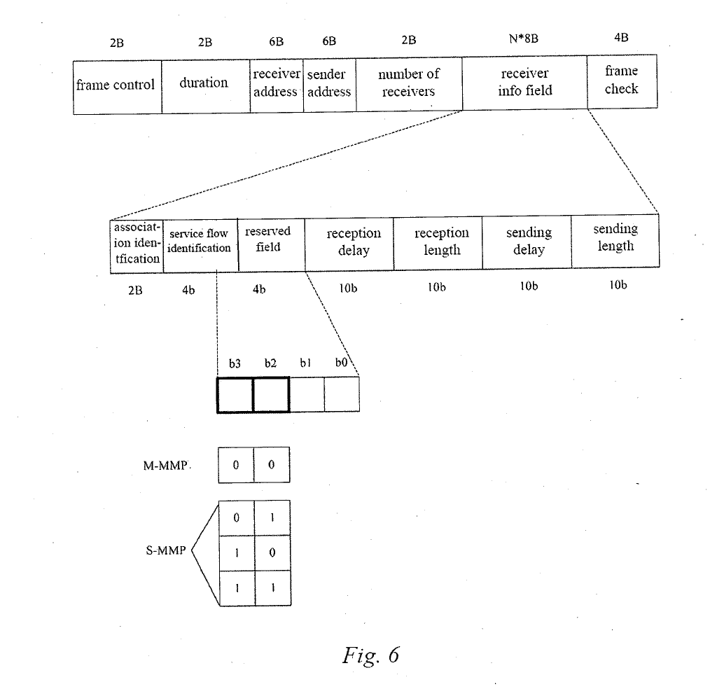

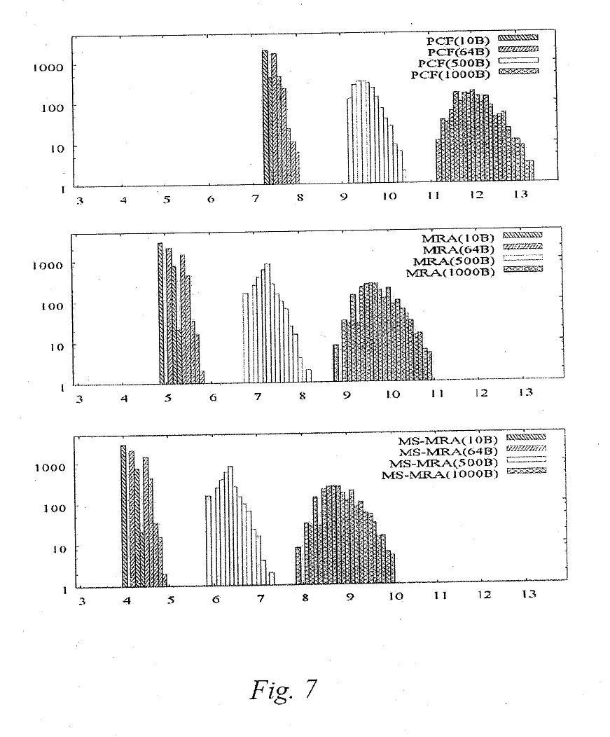

FIG. 6 provides the data receiving and sending situation that is defined for a client terminal STA1 in the reserved field of a receiver information field. Here, the master-MMP frame and slave-MMP frame are defined by using two high bits b3 and b2 of the reserved field. In the master-MMP, if the client terminal STA1 receives new downlink data from the access point AP for the first time, and the client terminal STA1 also sends new uplink data to the access point AP for the first time, then b3 and b2 are 00. In the master-MMP, the time and length of the downlink data D1 sent by the access point AP to client terminal STA1 and the time and length of the uplink data U1 sent by client terminal STA1 to the access point AP are determined by the Rx Offset, Rx Duration, Tx Offset, and Tx Duration of the receiver info field for the client terminal STA1.

Similarly, in the reserved field of the receiver information field for the client terminals STA2 and STA3, the two high bits b3 and b2 of the reserved field are also 00. In the master-MMP, the time and length of the downlink data D2 sent by the access point AP to client terminal STA2 and the time and length of the uplink data U2 sent by the client terminal STA2 to the access point AP are determined by the Rx Offset, Rx Duration, Tx Offset, and Tx Duration of the receiver information field for the client terminal STA2. In the master-MMP, the time and length of the downlink data D3 sent by the access point AP to the client terminal STA3 and the time and length of the uplink data U3 sent by the client terminal STA3 to the access point AP are determined by the Rx Offset, Rx Duration, Tx Offset, and Tx Duration of the receiver info field for the client terminal STA3.

After having received the aggregation packet, the client terminal STA1 learns that this MMP is the master-MMP by detecting that b3 and b2 are 00 and determines the time and length of the downlink data D1 sent by the access point AP received thereby and the time and length of the uplink data U1 sent to the access point AP according to the Rx Offset, Rx Duration, Tx Offset, and Tx Duration of the receiver information field. Similarly, after having received the aggregation packet, the client terminal STA2 learns that the MMP is the master-MMP by detecting that b3 and b2 are 00 and determines the time and length of the downlink data D2 sent by the access point AP that is received by the client terminal STA2 and the time and length of the uplink data U2 sent to the access point AP according to the Rx Offset, Rx Duration, Tx Offset, and Tx Duration of the receiver information field of the client terminal STA2. After having received the aggregation packet, the client terminal STA3 learns that the MMP is the master-MMP by detecting that b3 and b2 are 00 and determines the time and length of the downlink data D3 sent by the access point AP that is received by the client terminal STA3 and the time and length of the uplink data U3 sent to the access point AP according to the Rx Offset, Rx Duration, Tx Offset, and Tx Duration of the receiver info field of the client terminal STA3.

Assuming that errors occur in data D1 and D2 when they are being transmitted and data D3 is transmitted correctly, i.e., the client terminals STA1 and STA2 cannot send out the acknowledgement ACK for the received downlink data, only the client terminal STA3 sends out the acknowledgement ACK for the received downlink data. The client terminal STA3 aggregates the uplink data U3 sent to the access point AP together with the acknowledgement ACK of the downlink data received by the client terminal STA3 for sending out.

In addition, assume that the uplink data U1 sent by the client terminal STA1 to the access point AP and the uplink data U3 sent by the client terminal STA3 to the access point AP are transmitted correctly, and an error occurs in the uplink data U2 sent by the client terminal STA2 to the access point AP when it is being transmitted. At this point, the master multiple receiver aggregation phase (Master-MRA) ends.

The master multiple receiver aggregation phase (Master-MRA) is followed by a first slave multiple receiver aggregation phase (Slave-MRA). The access point AP only receives the acknowledgement ACK for data D3 sent by the client terminal STA3 but does not receive the acknowledgement ACK for data D1 and data D2 sent by client terminals STA1 and STA2. Consequently, the access point AP can determine that errors occurred in the downlink data D1 and D2 when they were being transmitted and it is required to retransmit data D1 and data D2. In addition, since the access point AP only receives the uplink data U1 sent by the client terminal STA1 and the uplink data U3 sent by the client terminal STA3, but does not receive the uplink data U2 sent by the client terminal STA2. Consequently, it can be determined that an error has occurred in the uplink data U2 during transmission and it requires the client terminal STA2 to retransmit data U2.

The access point AP aggregates the downlink data D1 and D2 to be sent to client terminals STA1 and STA2 into one packet, which packet includes a slave multiple receiver aggregation multi-poll frame (Slave-MMP), and which slave-MMP indicates that the downlink data D1 and D2 are retransmitted from the access point AP to the client terminals STA1 and STA2 over the downlink and indicates that the uplink data U2 is retransmitted from the client terminal STA2 to the access point AP via the uplink.

More particularly, during the slave multiple receiver aggregation phase (Slave-MRA), the slave-MMP is still defined by the reserved field (Reserved) of the receiver information field in the MMP frame as shown in FIG. 6. Here, there are three client terminals in the presently contemplated embodiment. As a result, the slave-MMP also has three receiver information fields, with each receiver info field defining a data receiving and sending situation for a client terminal. If the client terminal STA1 is required to resend the uplink data to the access point AP, then the reserved fields b3 and b2 in the receiver info field for the client terminal STA1 are 01. If the access point AP is required to resend the downlink data to the client terminal STA1, then the reserved fields b3 and b2 in the receiver information field for the client terminal STA1 are 10. Finally, if not only the client terminal STA1 is required to resend the uplink data to the access point AP but also the access point AP is required to resend the downlink data to the client terminal STA1, then the reserved fields b3 and b2 in the receiver info field for the client terminal STA1 are 11. The cases of the reserved fields in the receiver information field that are defined for the second client terminal STA2 and the third client terminal STA3 are similar to this.

As mentioned above, since errors have occurred in the downlink data D1 and D2 sent by the access point AP to client terminals STA1 and STA2 and an error has occurred in the uplink data U2 sent by STA2 to the access point AP, these data need to be retransmitted. Accordingly, for the client STA1 detention field, b3 and b2 are set as 10 in the reserved field for the client terminal STA1, i.e., the client terminal STA1 only receives the retransmitted data D1 but does not send data. In addition, the Tx Offset and Tx Duration in the receiver info field of the client terminal STA1 can also be set as 0, respectively, to indicate that the access point AP acknowledges reception of the uplink data U1, so it does not require the client terminal STA1 to retransmit the uplink data U1. That is, setting the Tx Offset and Tx Duration fields in the receiver information field of the slave-MMP achieves the acknowledgement of the uplink data U1 transmitted by the client terminal STA1 in the slave-MMP, and it is not required to take additional time to acknowledge the uplink data, and thus the cycle time is reduced. In the reserved field for the client terminal STA2, b3 and b2 are set as 11, i.e., the client terminal STA2 not only receives the retransmitted data D2 but also sends the retransmitted data U2. Similarly, the Tx Offset and Tx Duration in the receiver information field of the client terminal STA3 can also be set as 0, respectively, to indicate that the access point AP acknowledges the reception the uplink data U3.

During the first slave multiple receiver aggregation phase (Slave-MRA), after having received the aggregation packet sent by the access point AP, the client terminal STA1 learns that the MMP is a slave-MMP by detecting that b3 and b2 in the reserved field Reserved of the receiver information field of STA1 in the slave-MMP frame are 10, needs to re-receive the downlink data D1, and determines the time and length of the downlink data D1 sent by the access point AP received thereby according to the Rx Offset and Rx Duration in the receiver info field of STA1.

Similarly, after having received the aggregation packet sent by the access point AP, the client terminal STA2 learns that the MMP is a slave-MMP by detecting that b3 and b2 in the reserved field Reserved of the receiver information field of STA2 in the slave-MMP frame are 11, needs to receive the downlink data D2 again and resend the uplink data U2, and determines the time and length of the downlink data D2 sent by the access point AP received thereby and the time and length of the uplink data U2 sent to the access point AP according to the Rx Offset, Rx Duration, Tx Offset, and Tx Duration of the receiver info field of STA2.

Assuming that data D1 and D2 are retransmitted correctly, then client terminals STA1 and STA2, respectively, send the acknowledgements ACK for the received downlink data D1 and D2 and send these two acknowledgements ACK to the access point AP. In addition, assume that an error still occurs the uplink data U2 sent by the client terminal STA2 to the access point AP during retransmission. At this point, the first slave multiple receiver aggregation phase (Slave-MRA) ends.

The first slave multiple receiver aggregation phase (Slave-MRA) is followed by a second slave multiple receiver aggregation phase (Slave-MRA). Here, the access point AP receives the acknowledgement ACK of data D3, sent by client terminals STA1 and STA2. As a result, the access point AP can determine that the downlink data D1 and D2 have been retransmitted correctly. In addition, since the access point AP does not receive the uplink data U2 sent by the client terminal STA2, it can be determined that an error has occurred in the uplink data U2 during retransmission, and it requires the client terminal STA2 to retransmit data U2.

In the reserved field for the client terminal STA2, b3 and b2 are set as 01, i.e., the client terminal STA2 only sends the retransmitted data U2 and does not need to receive the retransmitted data.

During the second slave multiple receiver aggregation phase (Slave-MRA), after having received the packet including the slave-MMP sent by the access point AP, the client terminal STA2 learns that the MMP is a slave-MMP by detecting that b3 and b2 in the reserved field Reserved of the receiver information field of STA2 in the slave-MMP frame are 01, needs to resend the retransmitted data U2, and determines the time and length of the uplink data U2 resent thereby according to the Tx Offset and Tx Duration in the receiver information field of STA2. At this point, the second slave multiple receiver aggregation phase (Slave-MRA) ends.

In order to prove the effectiveness of the master-slave MRA method in accordance with the contemplated embodiments of the present invention, simulation of this method is performed and it is compared with the PCF and MRA methods. Here, the simulation was performed based on a simulator ns2. Here, is assumed that the I/O controller communicates with 32 I/O devices, i.e., one access point and 32 client terminals. This simulation is based on the following assumptions: only the packet error rate of the data frames is taken into account; since the packet error rate of the control/management frame is very small, it is not taken into account; the uplink and downlink use the same packet length; in order to obtain the maximum cycle time required, the number of times of retransmission is not limited; the GreenField mode in 802.11n is used during the whole simulation process; and the transmission rate of downlink data is 130 Mbps and there are 2 spatial streams, while the transmission rate of uplink data is 65 Mbps and there is 1 spatial stream.

FIG. 7 is a simulation result, in which the cycle times of the PCF, MRA, and master-slave MRA solutions are compared in the case where BER is 10⁻⁵ and the packet lengths are different. In FIG. 7, the horizontal axis represents the cycle time, with the unit being milliseconds ms. The vertical axis represents the number of the times that appear during one certain cycle time period. The uppermost diagram in FIG. 7 is the simulation result when the PCF solution is used and the packet lengths are different; the middle diagram is the simulation result when the MRA solution is used and the packet lengths are different; and the lowermost diagram is the simulation result when the master-slave MRA solution is used and the packet lengths are different. In this case, right slash, left slash, blank line, and grid line in each of the figures represent the simulation results when the packet lengths are 10 B, 64 B, 500 B, and 1000 B, respectively. It can be easily seen from FIG. 7 thatfirstly, no matter how long the packet lengths are, the master-slave MRA solution in accordance with the presently master-slave MRA solution in accordance with the presently contemplated embodiments of the invention always has the shortest cycle time. Secondly, with the increase of the packet length, the cycle time becomes more and more dispersed in all three solutions PCF, MRA, and master-slave MRA. However, the time interval of the cycle time for each solution is relatively stable, for example, the interval between the master-slave MRA and the PCF in this simulation is 3.5 ms. Furthermore, with the increase of the packet length, the cycle times in the three solutions PCF, MRA and master-slave MRA are all increased, which is due to the increase of the retransmission time required.

What are described above are merely the preferred embodiments of the present invention, and it should be pointed out that those skilled in the art can make some improvements and modifications without departing from the principles of the present invention, and these improvements and modifications should also be viewed as within the protection scope of the present invention.

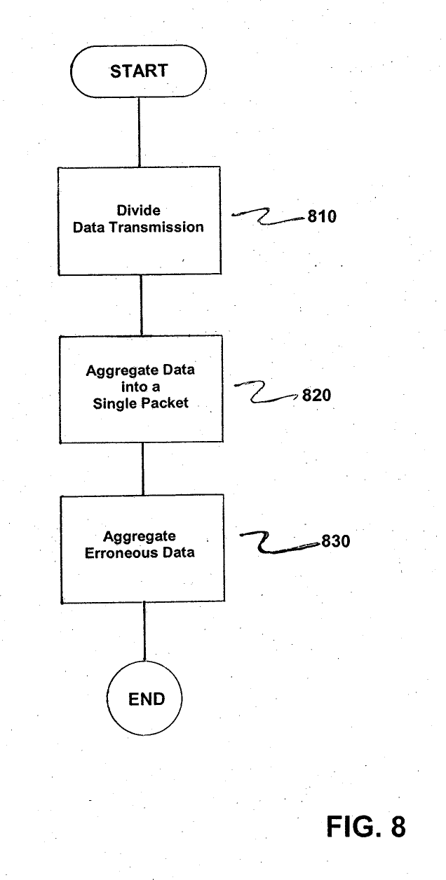

FIG. 8 is a flow chart of a communication method in an automation system in accordance with an embodiment of the invention, where the system comprising an access point and a plurality of client terminals receiving downlink data sent from the access point and sending uplink data to the access point, The method comprises dividing the data transmission into a master multiple receiver aggregation phase and a plurality of slave multiple receiver aggregation phases, as indicated in step 810.

The access point aggregates the data to be sent to the plurality of client terminals into a single packet for transmittal in the downlink during the master multiple receiver aggregation phase, as indicated in step 820. The access point aggregates, during the plurality of slave multiple receiver aggregation phases, data in which errors have occurred when being transmitted during the master multiple receiver aggregation phase into the single packet for the transmittal in the downlink, as indicated in step 830.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-10. (canceled)

11. A communication method in an automation system, said system comprising an access point and a plurality of client terminals receiving downlink data sent from the access point and sending uplink data to the access point, comprising:
dividing the data transmission into a master multiple receiver aggregation phase and a plurality of slave multiple receiver aggregation phases;
aggregating, by the access point, the data to be sent to the plurality of client terminals into a single packet for transmittal in the downlink during the master multiple receiver aggregation phase; and
aggregating, by the access point, during the plurality of slave multiple receiver aggregation phases, data in which errors have occurred when being transmitted during the master multiple receiver aggregation phase into the single packet for the transmittal in the downlink.

12. The communication method in an automation system as claimed in claim 11, wherein during the plurality of slave multiple receiver aggregation phases, the access point initially aggregates the data in which errors have occurred when being transmitted during a previous phase into the single packet for transmittal in the downlink, and the plurality of client terminals transmit to the access point uplink data in which errors have occurred when being transmitted during the previous phase.

13. The communication method in an automation system as claimed in claim 12, wherein the previous phase is one of the master multiple receiver aggregation phase and a previous slave multiple receiver aggregation phase of the plurality of slave multiple receiver aggregation phases.

14. The communication method in an automation system as claimed in claim 11, wherein each of said plural client terminals sends over the uplink to said access point an acknowledgement of downlink data received thereby together with uplink data which are to be sent thereby.

15. The communication method in an automation system as claimed in claim 12, wherein each of said plural client terminals sends over the uplink to said access point an acknowledgement of downlink data received thereby together with uplink data which are to be sent thereby.

16. The communication method in an automation system as claimed in claim 11, wherein the single packet sent during the master multiple receiver aggregation phase comprises a master multiple receiver aggregation multi-poll frame for indicating that the data is initially transmitted from the access point to the plurality of client terminals over the downlink for a first time and for indicating that the data is initially transmitted from the plurality of client terminals to the access point over the uplink.

17. The communication method in an automation system as claimed in claim 11, wherein the single packet sent during each of said plural slave multiple receiver aggregation phases comprises a slave multiple receiver aggregation multi-poll frame for indicating that the data is retransmitted from the access point to the plurality of client terminals over the downlink and for indicating that the data is retransmitted from the plurality of client terminals to the access point over the uplink.

18. The communication method in an automation system as claimed in claim 17, wherein the slave multiple receiver aggregation multi-poll frame comprises a plurality of receiver information fields, each said plural receiver information fields corresponding to a respective client terminal of the plurality of client terminals and each of said plural receiver information fields comprising four fields for respectively indicating a time when the respective client terminal of the plurality of client terminals receives the downlink data sent from the access point, a length of the downlink data received, a time when the client terminal of the plurality of client terminals sends the uplink data to the access point, and a length of the sent uplink data.

19. The communication method in an automation system as claimed in claim 18, wherein a receiver information field of the plurality of receiver information fields for indicating the time when the respective client terminal of the plurality of client terminals sends the uplink data to the access point and the length of the uplink data sent in said slave multiple receiver aggregation multi-poll frame are set to acknowledge the uplink data sent by the client terminal of the plurality of client terminals in a previous phase.

20. The communication method in an automation system as claimed in claim 16, wherein the single packet sent during each of said plural slave multiple receiver aggregation phases comprises a slave multiple receiver aggregation multi-poll frame for indicating that the data is retransmitted from the access point to the plurality of client terminals over the downlink and for indicating that the data is retransmitted from the plurality of client terminals to the access point over the uplink, and wherein the master multiple receiver aggregation multi-poll frame and the slave multiple receiver aggregation multi-poll frame are defined in a reserved domain of a multiple receiver aggregation multi-poll frame.

21. The communication method in an automation system as claimed in claim 20, wherein the master multiple receiver aggregation multi-poll frame and a slave multiple receiver aggregation multi-poll frame are defined by two bits in a reserved domain of a multiple receiver aggregation multi-poll frame.
